(19) United States
(12) Patent Application Publication
(10) Pub. No.: US 2004/0117225 A1
(43) Pub. Date: Jun. 17, 2004

(54) Method and system for delivering consumer-oriented materials

(76) Inventor: Boris Fridman, Princeton, NJ (US)

Correspondence Address: DUANE MORRIS LLP, 100 COLLEGE ROAD WEST, SUITE 100, PRINCETON, NJ, 08540-6604, US

(21) Appl. No.: 10/321,812

(22) Filed: Dec. 17, 2002

(51) Int. Cl. G06F 17/60

(52) U.S. Cl. 705/7; 705/1

(57) ABSTRACT

A method and system for enabling a user or consumer to through a wireless device including an identification code associated with the device, receive consumer-oriented materials from a desired business establishment is disclosed. The method comprises the steps of, associating a server operable to receive and send messages with the desired business establishment, the server identified by at least one business identification number (BID), wherein the server is responsive to a first BID entered by the user on the wireless device for identifying the user by the user identification code and transmitting at least one message containing the user identification code and information associated with the desired business establishment to the user, and is further responsive to a second BID entered by the user on the wireless device and identifying the user by the user identification code to terminate the transmission to the user, whereby the receipt and termination of information from the server is solely under the control of the user.

### FIELD OF THE INVENTION

This application is related to the field of advertising and more specifically to a system for enabling a consumer to selectively control the delivery of location-related, consumer-oriented materials.

### BACKGROUND OF THE INVENTION

Advertising continues to represent significant expenditures for retail and wholesale establishments in notifying existing and new customers of promotions, special sales, discounts that may be occurring currently or in the future and so on. Television, radio, newspapers, and flyers are means that advertisers use to disseminate promotional materials to the general public and in some cases, preferred customers. However, the customers ability to take advantage of the promotional items is limited to timely receiving the promotional materials and making a trip to the business or establishment during the period of the promotion. In addition, businesses also hold special sales that are advertised within the business establishment. Such special sales may be announced, for example, over a storewide speaker system and thus are known only to those within the store at the time of the announcement.

Consumers are inundated with continual distribution of promotional materials in magazines, through the mails and over the radio and television airwaves. However, this overuse by providing massive amounts of promotional materials may have a negative effect in that the consumer may begin to tune out, reject or ignore the promotional materials. Hence, while the advertiser or business is spending more campaign money for advertising, its money is not well spent as the consumer may not have sufficient time to read and react to the material. Some advertisers have begun providing promotional materials that are directed to the specific tastes, buying habits and desires of a user. However, this directed advertisement requires that the user provide private or personal information to the advertiser or business establishment. Many users or consumers are reluctant to provide such information and, hence, the advertisers' promotional materials do not reach as many users or consumers as desired.

Even with the timely distribution of the promotional materials, the retail, wholesale or similar establishment should provide indications of new promotions that are in store so as to supplement the user's or consumer's knowledge of the new promotions. This maintenance of the promotions is labor-intensive requiring installation and maintenance of signs of other promotional materials as well as those previously transmitted to the consumers. Furthermore, the signs and other promotional materials do no allow a business establishment to tailor its message to an individual consumer or to react quickly to pricing and inventory changes.

Furthermore, any establishment that provides services to consumers would benefit greatly if it could communicate effectively and discretely to consumers on its premises or consumers that expressed interests in its products. Equally, consumers would benefit greatly if they could receive timely and relevant information from business establishments of their choice whenever they happen such an establishment.

Hence, a system that enables an entity to provide promotional information upon a user's request and in relation to the user's location would be advantageous. This system would allow a user to control when he/she desires to receive such information and when to stop receiving such information. Therefore, the dissemination of promotional material is strictly under the control of the user. The system further reduces the cost to the retailer or advertiser in providing such information.

### SUMMARY OF THE INVENTION

A method and system for enabling a user or consumer to through a wireless device including an identification code associated with the device, receive consumer-oriented materials from a desired business establishment is disclosed. The method comprises the steps of, associating a server operable to receive and send messages with the desired business establishment, the server identified by at least one business identification number (BID), wherein the server is responsive to a first BID entered by the user on the wireless device for identifying the user by the user identification code and transmitting at least one message containing the user identification code and information associated with the desired business establishment to the user, and is further responsive to a second BID entered by the user on the wireless device and identifying the user by the user identification code to terminate the transmission to the user, whereby the receipt and termination of information from the server is solely under the control of the user.

### BRIEF DESCRIPTION OF THE DRAWINGS

In the figures:

FIG. 1 illustrates a mobile location-related, consumer-oriented delivery system in accordance with the principles of the invention;

FIG. 2 illustrates a mobile promotional delivery system in accordance with a second aspect of the present invention;

FIG. 3 illustrates a flow chart of the processing of the mobile delivery system in accordance with the principles of the present invention;

FIG. 4 illustrates a flow chart of one aspect of the mobile delivery system processing in accordance with the principles of the present invention;

FIG. 5 illustrates a system for implementing the processing illustrated herein; and

FIG. 6 illustrates a second embodiment of an exemplary process in accordance with the principles of the present invention.

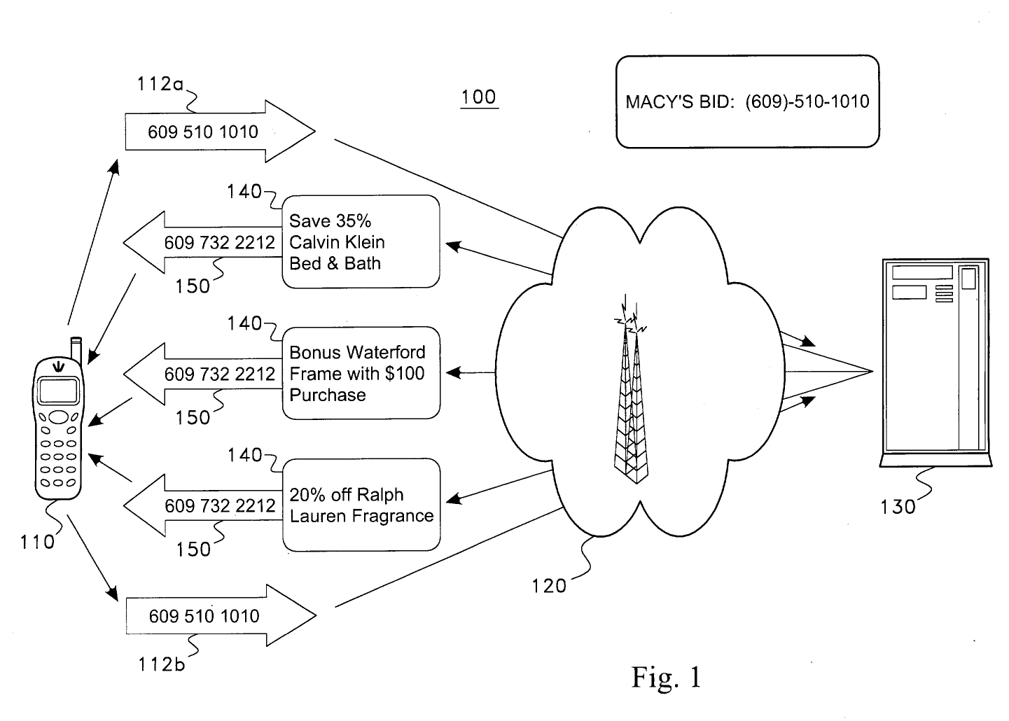

It is to be understood that these drawings are solely for purposes of illustrating the concepts of the invention and are not intended as a definition of the limits of the invention. The embodiments shown in FIGS. 1 through 6 and described in the accompanying detailed description are to be used as illustrative embodiments and should not be construed as the only manner of practicing the invention. Also, the same reference numerals, possibly supplemented with reference characters where appropriate, have been used to identify similar elements.

### DETAILED DESCRIPTION OF THE INVENTION

FIG. 1 illustrates one embodiment of a mobile delivery system 100 in accordance with the principles of the invention. In this embodiment, a consumer or user may initiate a request to receive promotional information, through the use of a transmitting/receiving (transceiver) mobile device, such as the illustrated wireless cellular telephone 110. The user accomplishes this by entering a business identification number (BID), e.g., a telephone number 112a, that initiates a request via a network 120 to a server or other similar device 130 associated with a retail, wholesale or other similar establishment.

Server 130 may then in response to the transmitted BID initiate a process via a software program that identifies consumer-oriented information items 140 associated with the retail establishment and transmits the identified consumer-oriented information items 140 via packet network 120 to the mobile device 110 using the user's identification code 150. The delivered consumer-oriented information items 140 may then be displayed on the display of cellular telephone 110 In one aspect of the invention, coupons for promotional items, tickets to events or reservation confirmations may be provided to the consumer.

Server 130 determines the manner of providing the requested consumer-oriented material based on the method the user initiated the request. For example, If the user dialed a phone number, then the user's phone number is determined from CALLER ID and consumer-oriented messages are returned via SMS (short message service). However, in other aspects of the invention, if the user sends an SMS message, then the user's own phone number is extracted from the header of the SMS message (similar to email ‘from’ field) and consumer-oriented messages are returned via SMS. On the other hand, if the user send an email message, then the user's email address is extracted from the header of email message (the ‘from’ field) and consumer-oriented message are returned via email. However, if the user entered a URL from a browser operating on a PDA or laptop computer, then the information items may be returned to the user's browser via conventional browser and web interaction. In this case, the display of the URL-type BID inside the establishment is advantageous as it allows the establishment to display more information associated with the returned consumer-oriented information. For example, images associated with the consumer-oriented information items or other timely and location relevant information.

The user, after reviewing the consumer-oriented information items 140 received may during or after the transmission of the consumer-oriented information items 140, decide to end the transmission by transmitting the same or a different BID, e.g., telephone number 112b, associated with the establishment. In this manner, the user is able to control the amount of consumer-oriented information items 140 received and the duration of the transmission.

For example, the user may enter a mall having a plurality of business, each business displaying a BID number associated with a server dedicated to a business or a server dedicated the mall. The user may then enter a BID number associated with a particular business or store. The server, in response to the received BID and the user's identification code, then begin transmitting consumer-oriented information items 140 associated with the BID number to the user. The user may view the received information items and when sufficient information has been reviewed, terminate the transmission of the information items by entering the same BID or a different BID, associated with termination. The server in response to the received BID, i.e., second reception of the same BID or a termination BID, terminates transmission to the user. The user may then select another BID associated with a another store. The server associated with this other store, responsive to the received BID and the user's identification code, then begins transmitting information items associated with this other store. The user may again terminate the transmission by entering the same BID or a termination BID, as previously described.

The present system is advantageous as it allows the user to control reception of consumer-oriented information items. It is further advantageous as the communication link between the user and server is only active for that period of connection to the server. Thereafter, the server, using the user's identification code, independently transmits consumer-oriented information items to the user. Hence, the user is not charged for occupying or utilizing communication bandwidth during the period of reception of consumer-oriented information items. Furthermore, the user may terminate transmission of consumer-oriented information any time during the transmission. Accordingly, the user determines how much and for how longer he desires to receive such information.

In one aspect of the invention, telephone number 112a entered on cellular telephone 110 may be a telephone number associated with a centralized location of retail or other similar establishment that has a plurality of retail, wholesale or other establishments, e.g. MACY'S, WALMART, J.C.PENNY, PUBLIX, GRAND UNION, COSTCO, etc. In this case, server 130 may be operable to deliver information items 140 associated with the retail or wholesale establishment at a plurality of different levels. For example, the user may enter a BID associated with a retail store that provides holiday promotional informational items 140 that are the same in each store of a large retail chain. In another aspect of the invention, the consumer may select a BID associated with a particular or desired store and receive information as consumer-oriented materials or other items 140 associated with the desired store. In still another aspect, the consumer may employ a GPS (Global Positioning Satellite) transmitter incorporated in the transceiving device. This would relay the geographic location to server 130. In this case, server 130 may provide location-relevant, consumer-oriented materials 140 associated with an establishment or store local to the user. In a preferred aspect, the BID, e.g., telephone number 112a, entered by the consumer or user may be local to a particular or specific retail or wholesale establishment, in which case, server 130 may provide information items 140 that are associated with the local establishment, e.g., time-limited sales or promotions, in addition to information items 140 that may be associated with store-wide sales or promotions. In another aspect, server 130 may provide information regarding individual departments within a local establishment that may have localized promotional materials 140. Accordingly, a consumer may select a department and view the promotional information items 140 within the selected department. In still another aspect of the invention, each department or section within a store or an establishment may have an associated BID, e.g., telephone number 112a, which when entered, directs server 130 to provide consumer-oriented information items 140 associated with the specific department or section. Hence, in accordance with the principles of the invention, the consumer directs server 130 to provide information items 140 that are immediately relevant to the consumer's needs and related to the consumer's position or location. Furthermore, the consumer is in control of the process to initiate and end the flow of information 140 received from server 130.

Availability of location determination may be made using known conventional methods. For example, Global Positioning Satellite (GPS)-enabled phones or network-based location services. NEXTEL, for example, has settled on providing location via cellular phone that are equipped with GPS receiver chips. SPRINT, on the other hand, using triangulation between cell sites to determine the position of the cellular telephone. Furthermore, the initiating of a request may indicate to the establishment that the consumer is willing to be located and tracked. Hence, the user is in control of determining whether or when their location is to be revealed and the establishment is able to deliver location-relevant materials.

In still another aspect of the invention, server 130 may include processes that “profile” or “track” the consumer's or user's buying patterns or desires. In this aspect, a user may establish a profile that directs server 130 to provide promotional information items 140 in a prioritized order. Server 130 may identify the consumer or user using the consumer's cellular telephone number via a “CALLER-ID” function or by another identification provided by the user. For example, if a consumer is profiled as preferring a particular manufacturer of clothing or a favorite flavor of ice cream, then promotional materials 140 associated with the preferred items may be provided before all other promotional items 140. Similarly, a consumer may provide a “wish list” of items, which server 130 can then assign a high priority to provide information regarding promotions or sales of items on the “wish list.”

While the present invention has been disclosed with regard to a single server or processor 130, it should be understood that server 130 may comprise one or more servers, operated individually or in combination to provide information to a user when requested. For example, server 130 may comprise a server local to a store or an establishment that provides promotional information 140 local to the store or establishment. This local server may then be in communication, via a network, such as the Internet, or Intranet, with a regional server, that provides consumer-oriented information items 140 regarding promotions among a group of stores within a region. Each of the regional servers may further be in communication with one or more national servers that provide promotional information items 140 regarding items on sale at a national level. In this case, each server is responsible, and programmed, for a desired operation to prevent duplication of effort and the introduction of errors. In one aspect, a local server may download, on a timely basis, and retain consumer-oriented information items stored on regional and national servers to reduce the need to continually access the associated regional and national servers. In this manner, an establishment may introduce, regionally or nationally, a time-limited sale for the benefit of consumers within the store or within a short distance from the store. It should be appreciated that the system disclosed is also capable of operating in a centralized configuration where one or more servers may be located at a single location and process each of the received requests from information stored at this single location.

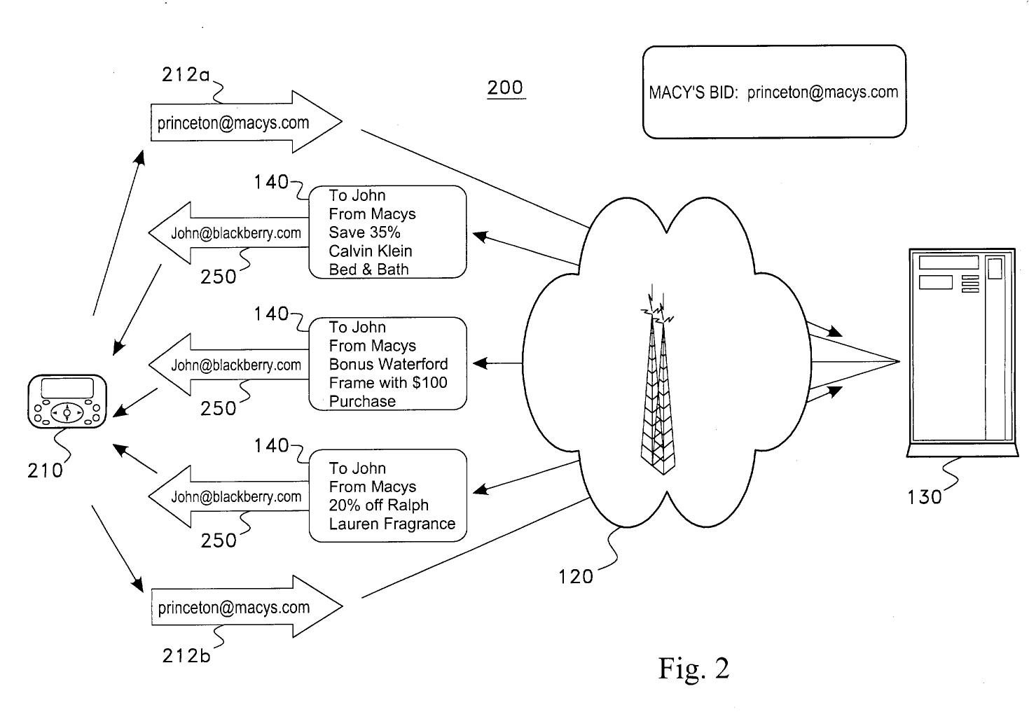

FIG. 2 illustrates a second aspect 200 of the present invention. In this aspect, a wireless digital device 210 such as BLACKBERRY or other PDA with wireless e-mail capabilities, is selected as the mobile transceiving device. In this case, digital device 210 allows a consumer or user to enter a digital address 212a, such as an email address, and to send a digital textual message to server 130. Server 130, in response to the identification of a digital textual message, e.g., e-mail, returns promotional information items 140, via network 120, to wireless digital device 210. In this case, the identification code, i.e., digital address 250, is used to identify the requesting wireless digital device 210. The user may then read the provided promotional information items 140 on a display. In another aspect, the user may listen to the provided promotional information items when the necessary text-to-audio software is included within digital wireless device 210.

It should be appreciated that wireless digital device 210 may be a Personal Digital Assistant (PDA) or a two-way paging device or a laptop computer or a TABLETPC. In the case of a PDA, server 130, responsive to the PDA requests, may provide promotional information items 140 in the form of Web pages, depicting both text and graphic images. In still another aspect, server 130 may provide video images that may be displayed on devices (not shown) operable to depict video images.

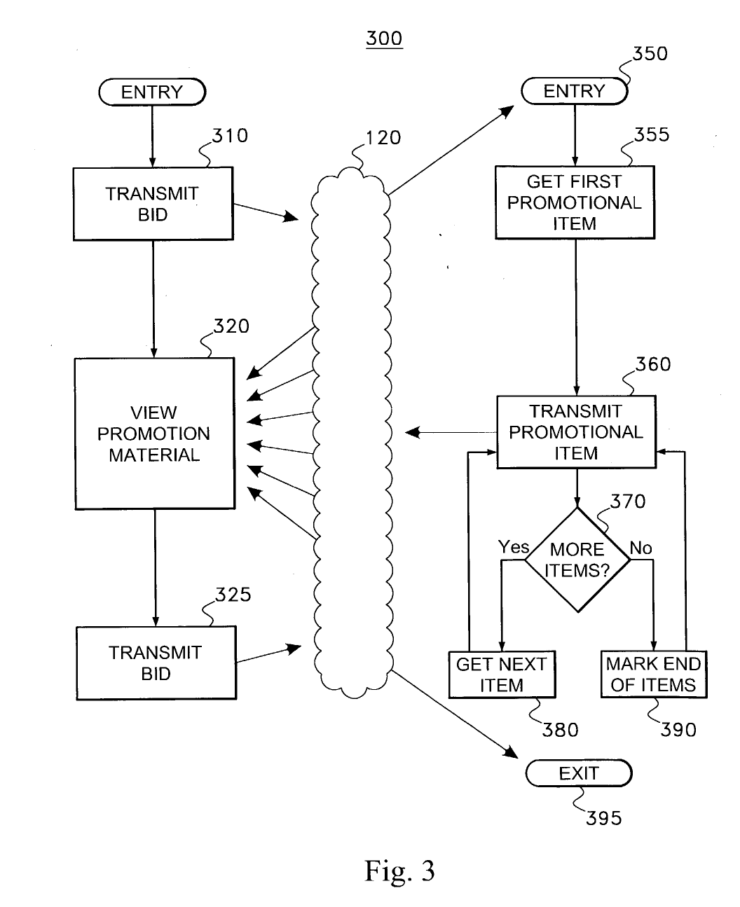

FIG. 3 illustrates a flow chart of an exemplary process 300 in accordance with the principles of the invention. In this process, a user may initiate a request to receive promotional information items 140 by dialing or by transmitting a message to a business identifier (BID), which may be a telephone number, as referred to in FIG. 1, or an email ID, as referred to in FIG. 2, or a similar identifier or combination of identifiers, e.g., MACY'S.HERALDSQUARE.MENS.Com, that uniquely identifies a retail establishment via wireless network 120.

Sample BIDs referring to the same location may be specified as:

| PHONE BID | EMAIL ID BID | URL BID |
|---|---|---|
| 212 567 2345 | hsq@macys.com | www.macys.com/hsq |
| 212 567 2356 | heraldsq.mens@macys.com | www.macys.com/hsq.mens |
| 818 788 2626 | epcot@disney.com | www.disney.com/epcot |

In this case, the Phone BID may be used when communicating from a mobile phone, the EMAIL ID when using a wireless PDA equipped with EMAIL, and the URL BID when using a wireless PDA with a browser. As should be appreciated, communication may also be performed from a laptop or other similar device having a capability to wirelessly send and receive information items.

Upon receiving a message addressed to the BID or when detecting a incoming call to the BID, process 350 is initiated at server 130. Process 350 selects a first promotional item 140 from a list of promotional items 140 at block 355. At block 360, the selected promotional item is returned, via network 120 to the requesting device using the user's identification code; in this case an e-mail address. At block 370, a determination is made whether more promotional items 140 are available on the list of promotional items 140. If the answer is in the affirmative, then a next promotional item 140 is selected at block 380 and processing continues at block 360 for transmission of the selected promotional item 140. If, however, the answer is negative, then an end of items marker is selected, at block 390, and transmitted, at block 360, to indicate that all the promotional items 140 have been transmitted. In this case, processing 350 may be dynamically concluded and the link between cellular telephone 110 and server 130, for example, may be extinguished, without user intervention.

Concurrently during the transmission of promotional informational items 140, a user may view or listen to the transmitted consumer-oriented items 140 on the receiving device, at block 320 At any time during the reception of consumer-oriented information items 140, the user may desire to end the transmission and the process 350 at server 130 by transmits the same or a different BID to direct processing 350 to end at block 395.

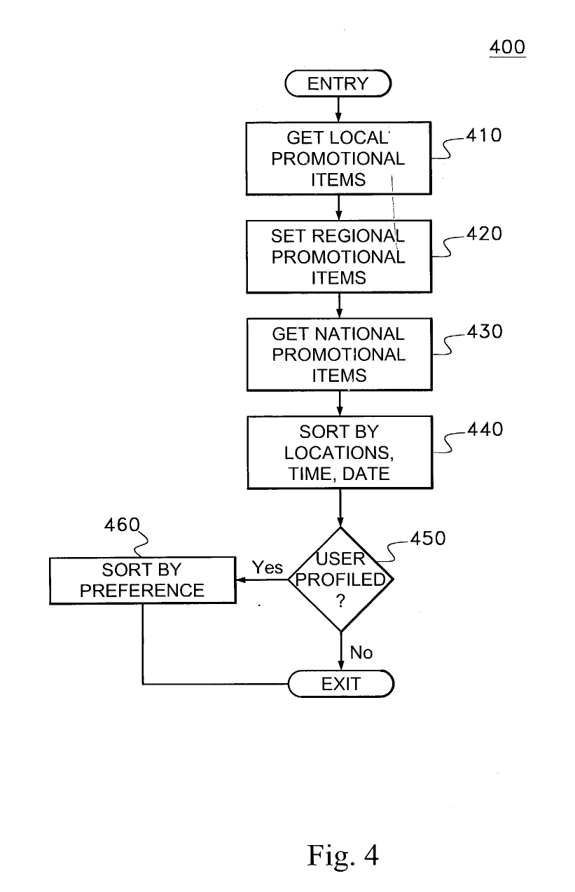

FIG. 4 illustrates a flow chart of an exemplary process 400 for selecting and prioritizing consumer-oriented information items 140 in accordance with one aspect of the present invention. In this exemplary process, information items 140 associated with a local server are obtained at block 410. At block 420, promotional items 140 associated with a next higher-level server, such as a regional server, are obtained, and at block 430 consumer-oriented items associated with a still higher-level server, such as a national server, are obtained. At block 440, the obtained consumer-oriented information items 140 are prioritized based on date, time and user location, if available. At block 450, a determination is made whether the user is a preferred user or is a profiled user. If the answer is in the affirmative, then the obtained promotional items are sorted with regard to the user's preferences or profile at block 460. Otherwise, the selection and prioritizing process is ended.

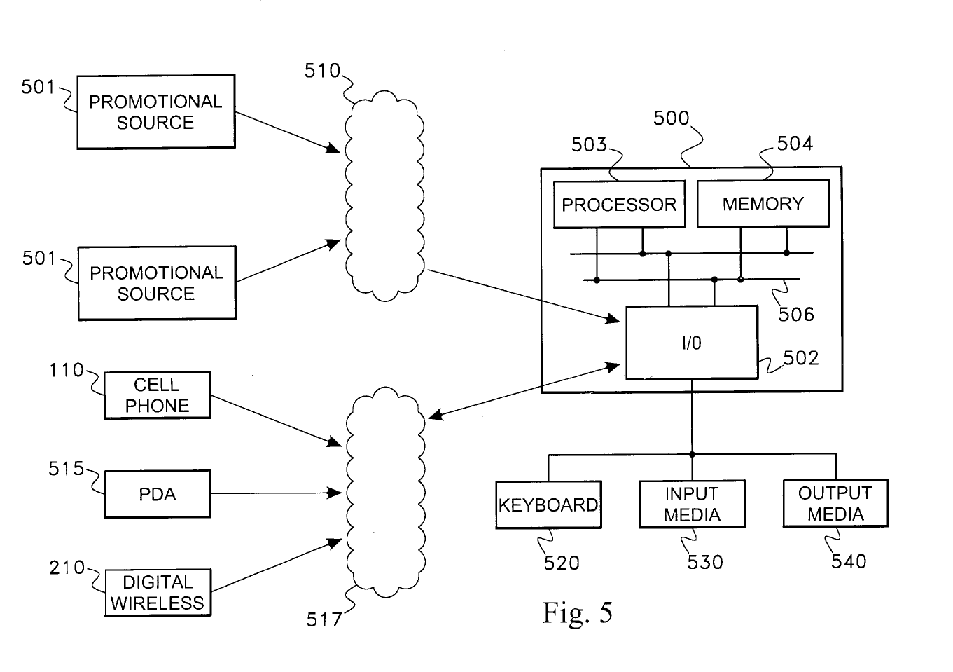

FIG. 5 illustrates an exemplary embodiment of a system 500 that may be used for implementing the principles of the present invention. System 500 may represent a desktop, laptop or palmtop computer, as well as portions or combinations of these and other devices. System 500 may contain one or more input/output devices 502, processors 503 and memories 504, that are operable to execute the processing illustrated in FIGS. 3 and 4.

System 500 may access one or more sources 501 that contain information items 140. Information items 140 contained on sources 501 may be stored in permanent or semi-permanent media, such as RAM, ROM, hard disk drive, optical disk drive or other image storage devices or may also be obtained dynamically and in real-time. Sources 501 may be accessed over one or more network connections 510 for transmitting and receiving information from, for example, a global computer communications network such as the Internet, a wide area network, a metropolitan area network, a local area network, a terrestrial broadcast system, a cable network, a satellite network, a wireless network, or a telephone network, as well as portions or combinations of these and other types of networks. Input/output devices 502, processors 503 and memories 504 may communicate over a communication medium 506. Communication medium 506 may represent for example, an internal communication bus or network, one or more internal connections of a circuit, circuit card or other apparatus, as well as portions and combinations of these and other communication media. Input data from sources 501 may be received by I/O device 502, and in accordance with one or more software programs that may be stored in memories 504 and executed by processors 503, may be transmitted over network 517 to a mobile wireless device, such as cellular telephone 110, PDA 515 or two-way pager device 210 for real-time viewing of the provided promotional information items 140. Network 517, similar to network 510, may be a global computer communications network such as the Internet, a wide area network, a metropolitan area network, a local area network, a terrestrial broadcast system, a cable network, a satellite network, a wireless network, or a telephone network, as well as portions or combinations of these and other types of networks. Network 510 and 517 may be the same or different portions or combinations of the same or different types of networks.

Processors 503 may be any means, such as general purpose or special purpose computing system, or may be a hardware configuration, such as a laptop computer, desktop computer, handheld computer, dedicated logic circuit, integrated circuit, Programmable Array Logic (PAL), Application Specific Integrated Circuit (ASIC), etc., that provides a known output in response to known inputs.

In a preferred embodiment, coding and decoding employing the principles of the present invention is implemented by computer readable code executed by processor 503. The code may be stored in the memory 504 or read/downloaded from a memory medium such as a CD-ROM or floppy disk (not shown) in communication with processor 503 or I/O device 502. In other embodiments, hardware circuitry may be used in place of, or in combination with, software instructions to implement the invention. For example, the elements illustrated herein may also be implemented as discrete hardware elements. System 500 may further be in communication with input media, such as keyboard 520, or input medium 530 that allows for manual changes of the promotional information items 140 received from sources 501 or the incorporation of additional promotional information items 140 not available from sources 501.

As should be understood, the term processor may represent one or more processing units or computing units in communication with one or more memory units and other devices, e.g., peripherals, connected electrically, electronically, or wirelessly to and communicating with the at least one processing unit. Furthermore, the devices may be electrically, electronically or wirelessly connected to the one or more processing units via internal busses, e.g., ISA bus, microchannel bus, PCI bus, PCMCIA bus, wireless etc., or one or more internal connections of a circuit, circuit card or other device, as well as portions and combinations of these and other communication media or an external network, e.g., the Internet and Intranet.

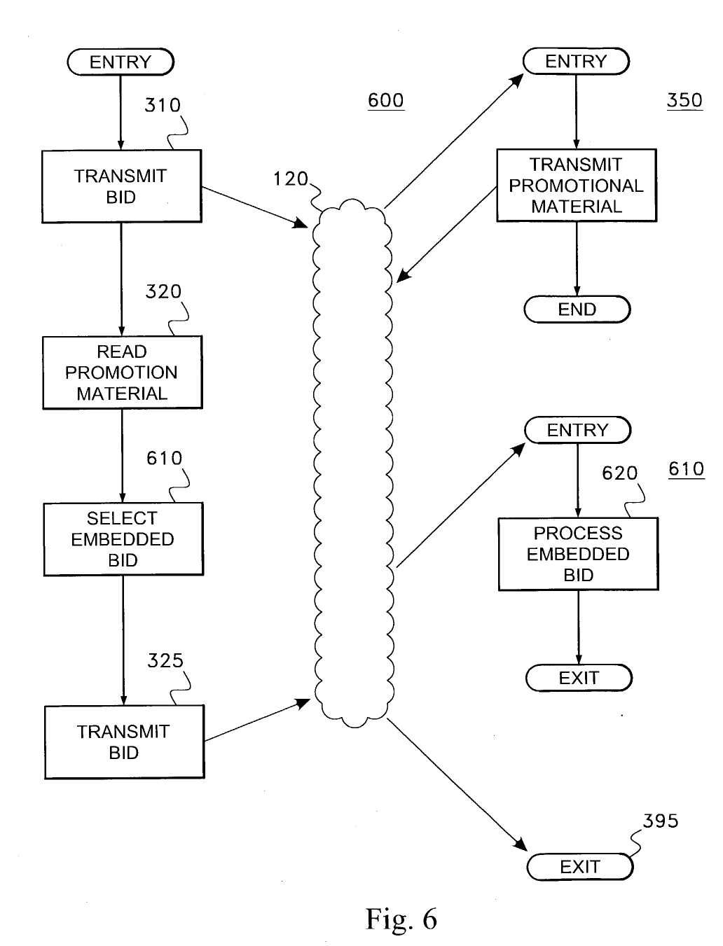

FIG. 6 illustrates a flow chart 600 of a second embodiment of the present invention. In this embodiment, promotional messages returned to a consumer by server 130 may include actionable messages allowing the consumer to act by making purchases, reserving seats at events or responding to surveys. For example, a user or consumer walking in New York City may view a BID, e.g., telephone number, URL, etc., associated with a ticket service for Broadway plays or sporting or musical events displayed on a billboard. The consumer may then request promotional information items 140, such as ticket availability, from the ticket service by entering the viewed BID, at block 310, which initiates process 350 on server 130. Process 350, as previously described, transmits to the user consumer-oriented information items 140 associated with the viewed BID. Accordingly, the BID provides timely information relevant to the user's desire to receive such information and the user's location.

At block 320, the user may view or listen to the returned consumer-oriented messages, which contain at least one embedded BID, e.g., telephone number, or URL, for each different play or event. The user, at block 610 may then initiate a second process, by sending a message using an embedded BID associated with the desired Broadway play, sport or musical event on server 130 or a server associated with the embedded BID. This second process may, for example, direct server 130, to allocate and purchase tickets to the play or event corresponding to the embedded BID. Server 130 may initiate process 610, which may transmit to the user messages that confirm purchase of tickets or additional BIDs to initiate additional processes

Alternatively, the user may transmit the initial BID or a different BID, at block 325, to end the reception of information items from the server, as previously described. In response to the second transmission of the BID or a different BID, processing on server 130 is concluded by exiting at block 395, as previously described.

In another aspect of the invention, a user may enter a BID on a mobile device that may be associated with a collection of stores or establishments, such as a shopping mall. The server associated with the mall may then transmit BIDs associated with stores within the mall. The user may then desire to receive information items related to a particular store by selecting and causing to be transmitted a BID associated with the desired store. Consumer-oriented information items, such as location of the store within the mall, directions to the store from the user's location, promotional or sale items within the store, may then be provided to the user. The user may then transmit the initial BID or a different BID to end transmission of consumer-oriented information items.

While there has been shown, described, and pointed out, fundamental novel features of the present invention as applied to preferred embodiments thereof, it will be understood that various omissions and substitutions and changes in the apparatus described, in the form and details of the devices disclosed, and in their operation, may be made by those skilled in the art without departing from the spirit of the present invention. For example, it is expressly intended that all combinations of those elements that perform substantially the same function in substantially the same way to achieve the same results are within the scope of the invention. Substitutions of elements from one described embodiment to another are also fully intended and contemplated.

What is claimed is:

1. A method for enabling a user or consumer to, through a wireless device including an identification code associated with the user, receive consumer-oriented materials from a desired business establishment, comprising the steps of:
associating a server operable to receive and send messages with said desired business establishment, said server identified by at least one business identification number (BID),
wherein said server is responsive to a first BID entered by said user on said wireless device for identifying said user by said user identification code and transmitting at least one message containing said user identification code and promotional information associated with said desired business establishment to said user; and is further responsive to a second BID entered by said user on said wireless device and identifying said user by said user identification code to terminate said transmission to said user, whereby the receipt and termination of information from said server is solely under control of said user.

2. The method as recited in claim 1, wherein said first BID and said second BID are the same.

3. The method as recited in claim 1, wherein said first BID and said second BID are different.

4. The method as recited in claim 1, wherein said second BID is unique.

5. The method as recited in claim 1, wherein said first and said second BID are selected from the group consisting of: telephone number, URL,, e-mail address, IP address.

6. The method as recited in claim 1, wherein said user identification code is selected from the group consisting of: telephone number,, IP address, or e-mail address

7. A method for providing consumer-oriented information items wirelessly to a user having a unique identification code, comprising the steps of:
transmitting a first identification code initiating a communication link, said communication link further initiating a request to receive said information items;
transmitting said information items in response to said request using said user-identification code.

8. The method as recited in claim 7, further comprising the step of:
transmitting a second identification code to end said information item transmission

9. The method as recited in claim 8, wherein said first and second identification codes are the same.

10. The method as recited in claim 8, wherein said first and second identification codes are different.

11. The method as recited in claim 7, wherein said first identification code is selected from the group consisting of: a telephone number, a URL, a digital address, e-mail address, IP address.

12. The method as recited in claim 8, wherein said second identification code is selected from the group consisting of: a telephone number, a URL, a digital address, e-mail address, IP address.

13. The method as recited in claim 7, further comprising the step of:
transmitting a third identification code, wherein said third identification code is embedded within one of said transmitted informational items.

14. The method as recited in claim 13, wherein said third identification code is selected from the group consisting of: a telephone number, a URL, a digital address, e-mail address, IP address

15. The method as recited in claim 7, further comprising the step of:
prioritizing an order of transmission of said consumer-oriented information items, wherein said order is based on an identification of said user.

16. The method as recited in claim 7, further comprising the step of:
prioritizing an order of transmission of said information items based on a location of said user.

17. The method as recited in claim 7, further comprising the step of:
prioritizing an order of transmission of said consumer-oriented information items based on a priority determined based on a geographic location.

18. The method as recited in claim 17, wherein said geographic location is selected from the group consisting of: local, regional, national.

19. The method as recited in claim 7, wherein said user-identification code is selected from the group consisting of: a telephone number, a URL, a digital address, e-mail address, IP address.

20. A device for providing consumer-oriented information items wirelessly to a user having a unique identification code, comprising:
a processor in communication with a memory, said processor operable to execute code for:
receiving a first identification code initiating a request to receive said promotional information items;
transmitting said consumer-oriented information items in response to said request to said user using said user-identification code.

21. The device as recited in claim 20, wherein said processor is further operable to execute code for:
receiving a second identification code to end said information item transmission.

22. The device as recited in claim 21, wherein said first and second identification codes are the same.

23. The device as recited in claim 21, wherein said first and second identification codes are different.

24. The device as recited in claim 20, wherein said first identification code is selected from the group consisting of: a telephone number, a URL, a digital address, e-mail address, IP address.

25. The device as recited in claim 21, wherein said second identification code is selected from the group consisting of: a telephone number, a URL, a digital address, e-mail address, IP address.

26. The device as recited in claim 21, wherein said processor is operable to execute code for:
transmitting a third identification code, wherein said third identification code is embedded within one of said transmitted consumer-oriented information items.

27. The device as recited in claim 26, wherein said third identification code is selected from the group consisting of; a telephone number, a URL, a digital address, e-mail address, IP address.

28. The device as recited in claim 20, wherein said processor is further operable to execute code for:
prioritizing an order of transmission of said consumer-oriented information items, wherein said order is based on an identification of said user.

29. The device as recited in claim 20, wherein said processor is further operable to execute code for:
prioritizing an order of transmission of said consumer-oriented information items based on an a location of said user.

30. The device as recited in claim 20, wherein said processor is further operable to execute code for:
prioritizing an order of transmission of said consumer-oriented information items based on a priority determined based on geographic location.

31. The device as recited in claim 30 wherein said geographic location is selected from the group consisting of: local, regional, national.

32. The device as recited in claim 20, wherein said user-identification code is selected from the group consisting of: a telephone number, a URL, a digital address, e-mail address, IP address.

33. The device as recited in claim 20, wherein said code is contained in said memory.

34. The device as recited in claim 20, further comprising:
an I/O device in communication with said processor operable to receive data from and provide data to said processor.

35. The device as recited in claim 34, wherein said I/O device is in communication with said memory operable to receive data from and provide data to said memory.

36. A system for interactively providing consumer-oriented information items to a user having a user-identification code over a wireless communication link, said system comprising:
a first transceiving device operable to transmit a first identification code initiating a wireless communication link, said code further initiating a request to receive said promotional information items;
a server operable to transmit said consumer-oriented materials in response to said request wirelessly using said user-identification code.

37. The system as recited in claim 36, wherein said first transceiving device is operable to transmit a second identification code to end said consumer-oriented information item transmission

38. The system as recited in claim 37, wherein said first and second identification codes are the same.

39. The system as recited in claim 37, wherein said first and second identification codes are different.

40. The system as recited in claim 36, wherein said first identification code is selected from the group consisting of: a telephone number, a URL, a digital address, e-mail address, IP address.

41. The system as recited in claim 37, wherein said second identification code is selected from the group consisting of: a telephone number, a URL, a digital address, e-mail address, IP address.

42. The system as recited in claim 36, wherein said first transceiving device is operable to:
transmit a third identification code, wherein said third identification code is embedded within one of said transmitted consumer-oriented informational items.

43. The system as recited in claim 42 wherein said third identification code is selected from the group consisting of: a telephone number, a URL, a digital address, e-mail address, IP address.

44. The system as recited in claim 36, wherein said server is operable to prioritize an order of transmission of said consumer-oriented information items, wherein said order is based on an identification of said user.

45. The system as recited in claim 36, wherein said server is operable to prioritize an order of transmission of said consumer-oriented information items based on an a location of said user.

46. The system as recited in claim 36, wherein said server is operable to prioritize an order of transmission of said consumer-oriented information items based on a priority determined based on geographic location.

47. The system as recited in claim 46 wherein said geographic location is selected from the group consisting of: local, regional, national.

48. The system as recited in claim 36, wherein said user-identification code is selected from the group consisting of: a telephone number, a URL, a digital address, e-mail address, IP address.

49. The system as recited in claim 36 wherein said first transceiving device is selected from the group consisting of: a cellular telephone, a PDA, a BLACKBERRY device, FIREWIRE device, an infrared device, a laptop computer.
